(19) United States
(12) Patent Application Publication
(10) Pub. No.: US 2012/0173653 A1
(43) Pub. Date: Jul. 5, 2012

(54) VIRTUAL MACHINE MIGRATION IN FABRIC ATTACHED MEMORY

(75) Inventors: Patrick M. Bland, Raleigh, NC (US); John M. Borkenhagen, Rochester, MN (US); Thomas M. Bradicich, Apex, NC (US); Dhruv M. Desai, Cary, NC (US); Jimmy G. Foster, SR., Morrisville, NC (US); Joseph J. Jakubowski, Cary, NC (US); Randolph S. Kolvick, Durham, NC (US); Makoto Ono, Cary, NC (US)

(73) Assignee: INTERNATIONAL BUSINESS MACHINES CORPORATION, Armonk, NY (US)

(21) Appl. No.: 12/981,611

(22) Filed: Dec. 30, 2010

(51) Int. Cl. G06F 15/167

(52) U.S. Cl. 709/213

(57) ABSTRACT

A computer program product and computer implemented method are provided for migrating a virtual machine between servers. The virtual machine is initially operated on a first server, wherein the first server accesses the virtual machine image over a network at a memory location within fabric attached memory. The virtual machine is migrated from the first server to a second server by flushing data to the virtual machine image from cache memory associated with the virtual machine on the first server and providing the state and memory location of the virtual machine to the second server. The virtual machine may then operate on the second server, wherein the second server accesses the virtual machine image over the network at the same memory location within the fabric attached memory without copying the virtual machine image.

### BACKGROUND

1. Field of the Invention

The present invention relates to the management of virtual machines.

2. Background of the Related Art

In a cloud computing environment, a user is assigned a virtual machine somewhere in the computing cloud. The virtual machine provides the software operating system and has access to physical resources, such as input/output bandwidth, processing power and memory capacity, to support the user's application. Provisioning software manages and allocates virtual machines among the available computer nodes in the cloud. Because each virtual machine runs independent of other virtual machines, multiple operating system environments can co-exist on the same physical computer in complete isolation from each other.

Virtual machine management policies may be implemented by a provisioning manager application on a management node. For example, a management node of a multi-server chassis include a provisioning manager that provisions and migrates virtual machines to achieve some operational objective. Using the ability to migrate a virtual machine, the provisioning manager can manage the use of system resources. Still, the migration itself requires system resources and imparts a latency in the availability of the virtual machine while it is being copied from one server to another. These and other challenges threaten to limit the efficiency improvements that can be achieved through virtual machine migration.

### BRIEF SUMMARY

One embodiment of the present invention provides a computer-implemented method for migrating a virtual machine. The virtual machine is initially operated on a first server, wherein the first server accesses the virtual machine image over a network at a memory location within fabric attached memory. The virtual machine is migrated from the first server to a second server by flushing data to the virtual machine image from cache memory associated with the virtual machine on the first server and providing the state and memory location of the virtual machine to the second server. The virtual machine may then operate on the second server, wherein the second server accesses the virtual machine image over the network at the same memory location within the fabric attached memory without copying the virtual machine image.

### BRIEF DESCRIPTION OF THE SEVERAL VIEWS OF THE DRAWINGS

FIG. 1 depicts an exemplary computer that may be utilized in accordance with the present invention.

FIG. 2 illustrates an exemplary blade chassis that may be utilized in accordance with the present invention.

FIG. 3 depicts another embodiment of the present disclosed method utilizing multiple physical computers in a virtualized rack.

FIGS. 4A-4C are schematic diagrams illustrating live migration of a virtual machine migration using fabric attached partitioned memory.

FIG. 5 is a flowchart of a method of the present invention.

### DETAILED DESCRIPTION

One embodiment of the present invention provides a computer-implemented method for migrating a virtual machine. The virtual machine is initially operated on a first server, wherein the first server accesses the virtual machine image over a network at a memory location within fabric attached memory, such as a memory subsystem attached with a computing subsystem through high speed network. The virtual machine is migrated from the first server to a second server by flushing data to the virtual machine image from cache memory associated with the virtual machine on the first server and providing the state and memory location of the virtual machine to the second server. The virtual machine may then operate on the second server, wherein the second server accesses the virtual machine image over the network at the same memory location within the fabric attached memory without copying the virtual machine image.

Various embodiments of the invention provide the advantage that the virtual machine image does not have to be copied. This reduces migration latency (i.e., the amount of time it takes to migrate a virtual machine and resume operation), conserves the use of memory, and eliminates the use of network bandwidth to move the virtual machine image. By providing the second server (i.e., the target server) with the state and memory location of the virtual machine, the second server is able to access the virtual machine image over the network and resume operation of the virtual machine using the original virtual machine image.

In one embodiment, a first hypervisor on the first server provides the state and memory location of the virtual machine, and a second hypervisor on the second server receives the state and memory location of the virtual machine. A provisioning manager, such as IBM's Active Energy Manager or and Director VM Control, initiates the migration.

In another embodiment, the virtual machine continues to operate on the first server during migration. This movement of a VM between servers while the VM continues to handle the workload is referred to as a “live migration.”

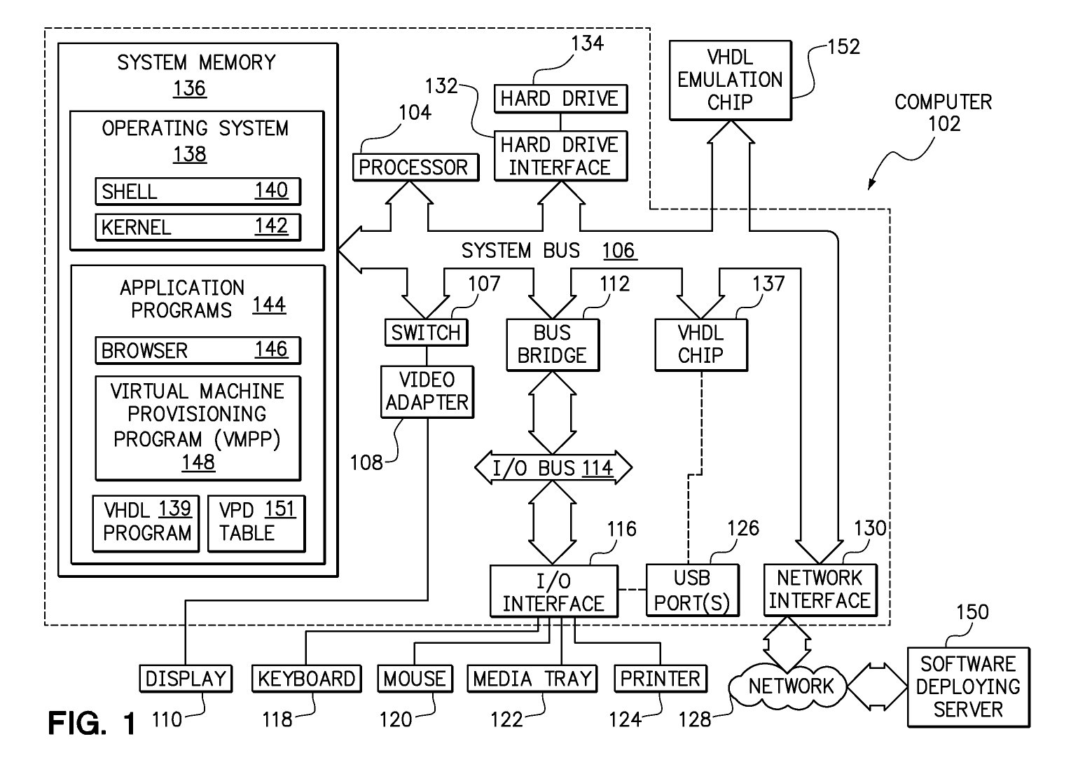

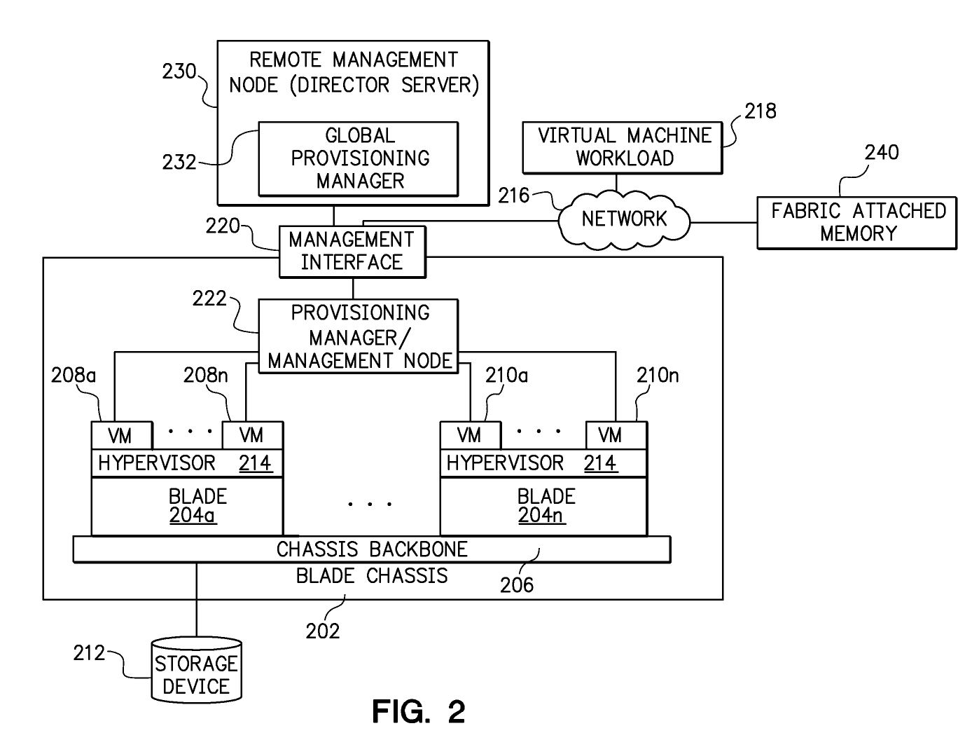

With reference now to the figures, FIG. 1 is a block diagram of an exemplary computer 102, which may be utilized by the present invention. Note that some or all of the exemplary architecture, including both depicted hardware and software, shown for and within computer 102 may be utilized by software deploying server 150, as well as provisioning manager/management node 222, and server blades 204a-n shown below in FIG. 2. Note that while blades described in the present disclosure are described and depicted in exemplary manner as server blades in a blade chassis, some or all of the computers described herein may be stand-alone computers, servers, or other integrated or stand-alone computing devices. Thus, the terms “blade,” “server blade,” “computer,” “server,” and “compute node” are used interchangeably in the present descriptions.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions (e.g., virtual machine provisioning program—VMPP 148 described below) that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below) external USB port(s) 126. While the format of the ports connected to I/O interface 116 may be any known to those skilled in the art of computer architecture, in a preferred embodiment some or all of these ports are universal serial bus (USB) ports.

As depicted, the computer 102 is able to communicate with a software deploying server 150 via network 128 using a network interface 130. The network 128 may be an external network such as the Internet, or an internal network such as an Ethernet or a virtual private network (VPN).

A hard drive interface 132 is also coupled to the system bus 106. The hard drive interface 132 interfaces with a hard drive 134. In a preferred embodiment, the hard drive 134 communicates with a system memory 136, which is also coupled to the system bus 106. System memory is defined as a lowest level of volatile memory in the computer 102. This volatile memory includes additional higher levels of volatile memory (not shown), including, but not limited to, cache memory, registers and buffers. Data that populates the system memory 136 includes the operating system (OS) 138 and application programs 144 of the computer 102.

The operating system 138 includes a shell 140 for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 is a text-based, line-oriented user interface, the present invention will equally well support other user interface modes, such as graphical, voice, gestural, etc.

As depicted, the operating system 138 also includes kernel 142, which includes lower levels of functionality for the operating system 138, including providing essential services required by other parts of the operating system 138 and application programs 144, including memory management, process and task management, disk management, and mouse and keyboard management.

The application programs 144 include an optional renderer, shown in exemplary manner as a browser 146. The browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

Application programs 144 in the system memory of the computer 102 (as well as the system memory of the software deploying server 150) also include a virtual machine provisioning program (VMPP) 148. The VMPP 148 includes code for implementing the processes described below, including those described in FIGS. 2-6. The VMPP 148 is able to communicate with a vital product data (VPD) table 151, which provides required VPD data described below. In one embodiment, the computer 102 is able to download the VMPP 148 from software deploying server 150, including in an on-demand basis. Note further that, in one embodiment of the present invention, the software deploying server 150 performs all of the functions associated with the present invention (including execution of VMPP 148), thus freeing the computer 102 from having to use its own internal computing resources to execute the VMPP 148.

Optionally also stored in the system memory 136 is a VHDL (VHS IC hardware description language) program 139. VHDL is an exemplary design-entry language for field programmable gate arrays (FPGAs), application specific integrated circuits (ASICs), and other similar electronic devices. In one embodiment, execution of instructions from VMPP 148 causes VHDL program 139 to configure VHDL chip 137, which may be an FPGA, ASIC, etc.

In another embodiment of the present invention, execution of instructions from the VMPP 148 results in a utilization of the VHDL program 139 to program a VHDL emulation chip 152. The VHDL emulation chip 152 may incorporate a similar architecture as described above for VHDL chip 137. Once VMPP 148 and VHDL program 139 program the VHDL emulation chip 152, VHDL emulation chip 152 performs, as hardware, some or all functions described by one or more executions of some or all of the instructions found in VMPP 148. That is, the VHDL emulation chip 152 is a hardware emulation of some or all of the software instructions found in VMPP 148. In one embodiment, VHDL emulation chip 152 is a programmable read only memory (PROM) that, once burned in accordance with instructions from VMPP 148 and VHDL program 139, is permanently transformed into a new circuitry that performs the functions needed to perform the process described below in FIGS. 2-6.

The hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

FIG. 2 is a diagram of an exemplary blade chassis 202 operating as a “cloud” environment for a pool of resources. Blade chassis 202 comprises a plurality of blades 204a-n (where “n” is an integer) coupled to a chassis backbone 206. Each blade is able to support one or more virtual machines (VMs). As known to those skilled in the art of computers, a VM is a software implementation (emulation) of a physical computer. A single physical computer (blade) can support multiple VMs, each running the same, different, or shared operating systems. In one embodiment, each VM can be specifically tailored and reserved for executing software tasks 1) of a particular type (e.g., database management, graphics, word processing etc.); 2) for a particular user, subscriber, client, group or other entity; 3) at a particular time of day or day of week (e.g., at a permitted time of day or schedule); etc.

As shown in FIG. 2, the blade 204a supports a plurality of VMs 208a-n (where “n” is an integer), and the blade 204n supports a further plurality of VMs 210a-n (wherein “n” is an integer). The blades 204a-n are coupled to a storage device 212 that provides a hypervisor 214, guest operating systems, and applications for users (not shown). Provisioning software from the storage device 212 is loaded into the provisioning manager/management node 222 to allocate virtual machines among the blades in accordance with various embodiments of the invention described herein. The computer hardware characteristics are communicated from the VPD 151 to the VMPP 148 (per FIG. 1). The VMPP may communicate the computer physical characteristics to the blade chassis provisioning manager 222 to the management interface 220 through the network 216, and then to the Virtual Machine Workload entity 218.

Note that chassis backbone 206 is also coupled to a network 216, which may be a public network (e.g., the Internet), a private network (e.g., a virtual private network or an actual internal hardware network), etc. Network 216 permits a virtual machine workload 218 to be communicated to a management interface 220 of the blade chassis 202. This virtual machine workload 218 is a software task whose execution is requested on any of the VMs within the blade chassis 202. The management interface 220 then transmits this workload request to a provisioning manager/management node 222, which is hardware and/or software logic capable of configuring VMs on fabric attached memory 240 to execute the requested software task. In essence the virtual machine workload 218 manages the overall provisioning of VMs by communicating with the blade chassis management interface 220 and provisioning management node 222. Then this request is further communicated to the virtual machine provisioning program 148 in the generic computer system (See FIG. 1). Note that the blade chassis 202 is an exemplary computer environment in which the presently disclosed system can operate. The scope of the presently disclosed system should not be limited to merely blade chassis, however. That is, the presently disclosed method and process can also be used in any computer environment that utilizes some type of workload management, as described herein. Thus, the terms “blade chassis,” “computer chassis,” and “computer environment” are used interchangeably to describe a computer system that manages multiple computers/blades/servers.

FIG. 2 also shows an optional remote management node 230, such as an IBM Director Server, in accordance with a further embodiment of the invention. The remote management node 230 is in communication with the chassis management node 222 on the blade chassis 202 via the management interface 220, but may communicate with any number of blade chassis and servers. A global provisioning manager 232 is therefore able to communicate with the (local) provisioning manager 222 and work together to perform the methods of the present invention. The optional global provisioning manager is primarily beneficial in large installations having multiple chassis or racks of servers, where the global provisioning manager can coordinate inter-chassis migration or allocation of VMs.

The global provisioning manager preferably keeps track of the VMs of multiple chassis or multiple rack configurations. If the local provisioning manager is able, that entity will be responsible for migrating VMs within the chassis or rack and send that information to the global provisioning manager. The global provisioning manager would be involved in migrating VMs among multiple chassis or racks, and perhaps also instructing the local provisioning management to migrate certain VMs. For example, the global provisioning manager 232 may build and maintain a table containing the same VM data as the local provisioning manager 222, except that the global provisioning manager would need that data for VMs in each of the chassis or racks in the multiple chassis or multiple rack system. The tables maintained by the global provisioning manager 232 and each of the local provisioning managers 222 would be kept in sync through ongoing communication with each other. Beneficially, the multiple tables provide redundancy that allows continued operation in case one of the provisioning managers stops working.

Fabric attached memory 240 is also accessible to each of the blade servers 204a-n in the blade chassis 202 via input/output over the network 216. Accordingly, a virtual machine image associated with each virtual machine 208a-n on a first blade server 204a, as well as each virtual machine 210a-n on a second or further blade server 204n, is stored on the fabric attached memory 240.

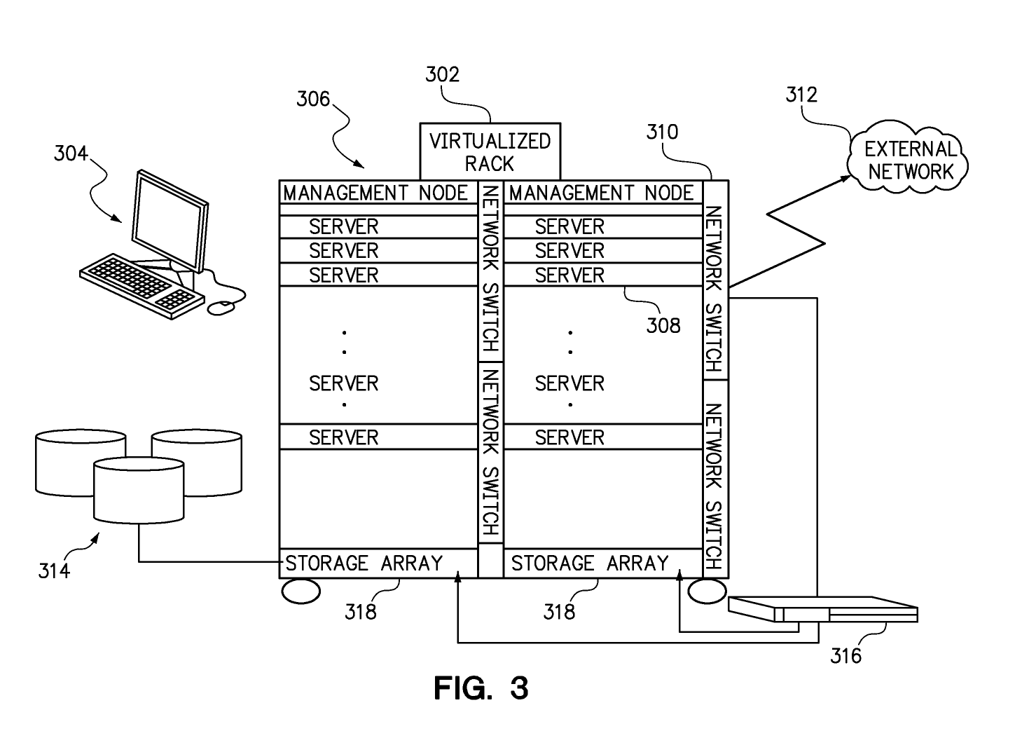

FIG. 3 presents one embodiment of the present invention with multiple physical servers in a 19-inch rack environment. This configuration is similar to the configuration 202 shown in FIG. 2 except FIG. 3 depicts a virtualized rack 302. A user 304 is able to transmit a request for execution of a software task to a management node 306 (analogous to provisioning manager/management node 222 shown in FIG. 2). Based on the I/O capabilities of a particular server 308 and its coupled network switch 310 to communicate with the external network 312 and storage devices 314 (via gateway 316 and virtualized storage arrays 318), the user's request is addressed to the appropriate and optimal computer (e.g., server 308). The virtualized rack 302 is, for example, a blade chassis holding multiple servers. Each physical server (including server 308) has I/O network adapters to support input/output traffic. To determine the optimal number of virtual machines able to execute on the server, the provisioning manager must be able to retrieve the network configuration of the physical server (I/O capability) and coordinate this information to properly provision VMs on each of the servers.

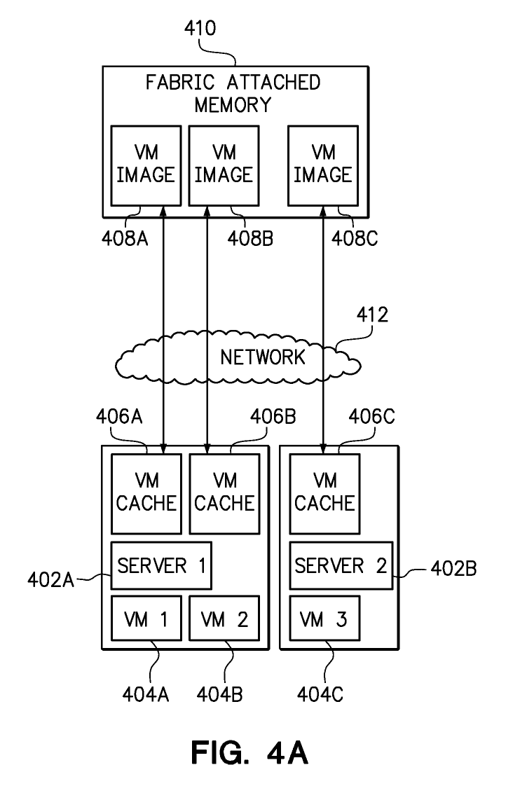

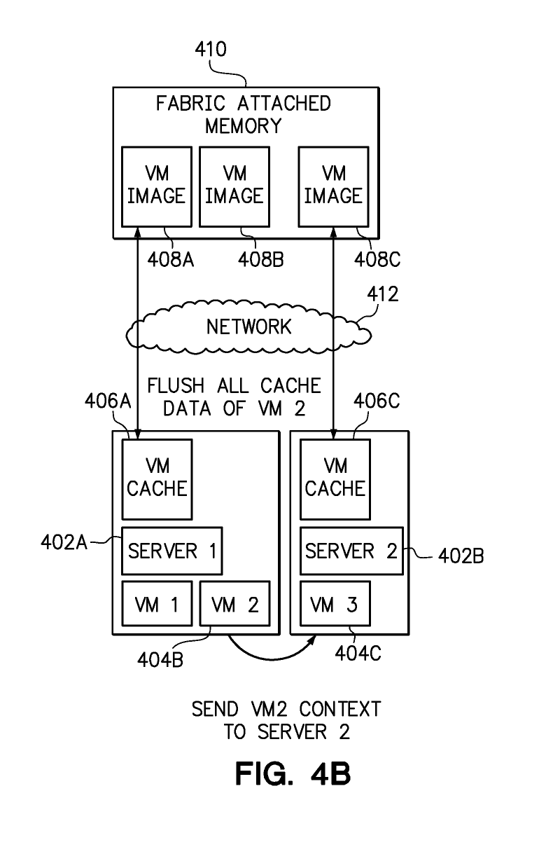

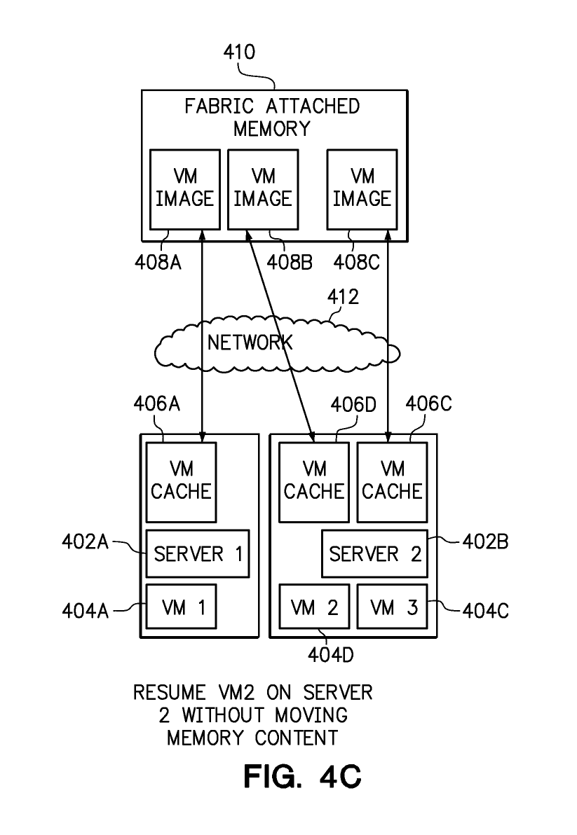

FIGS. 4A-4C are schematic diagrams illustrating live migration of a virtual machine that is stored on fabric attached memory. In FIG. 4A, a pair of servers 402A, 402B (Server 1 and Server 2) are running three virtual machines 404A, 404B, 404C (VM 1, VM 2, and VM 3). Each of the three virtual machines has use of VM cache 406A, 406B, 406C, respectively, but stores its virtual machine image 408A, 408B, 408C on a portion of fabric attached memory 410 that is accessible through the network 412 using high speed input/output, such as PCIe Gen3×16. FIG. 4A shows a first operating configuration where VM 1 and VM 2 runs on Server 1, while VM 3 runs on Server 2. In the present example, a local or global provisioning manager (See FIG. 2) has used some criteria to determine that VM2 should be migrated from Server 1 to Server 2. Many such criteria are possible as will be understood by those having ordinary skill in the art.

In FIG. 4B, the VM cache 406B (see FIG. 4A) that is associated with VM 2 has been flushed to the respective VM image 408B over the network 412, where it is used to update the VM image that is stored on the fabric attached memory. In addition, the VM 2 context, including the virtual machine state and the location of the VM image 408B, that was previously utilized by the VM 2 (404B) on Server 1 (402A) is provided to Server 2 (402B).

In FIG. 4C, the migration of VM 2 is completed when Server 2, presumably through action of a provisioning manager and/or hypervisor (see FIG. 2), provisions a new virtual machine, here VM 2 (404D), on Server 2. Server 2 will run VM 2 by accessing the same VM image 408B on the fabric attached memory 410 without copying the VM image. Server 2 provides for VM cache 406D, which is used by VM2 (404D).

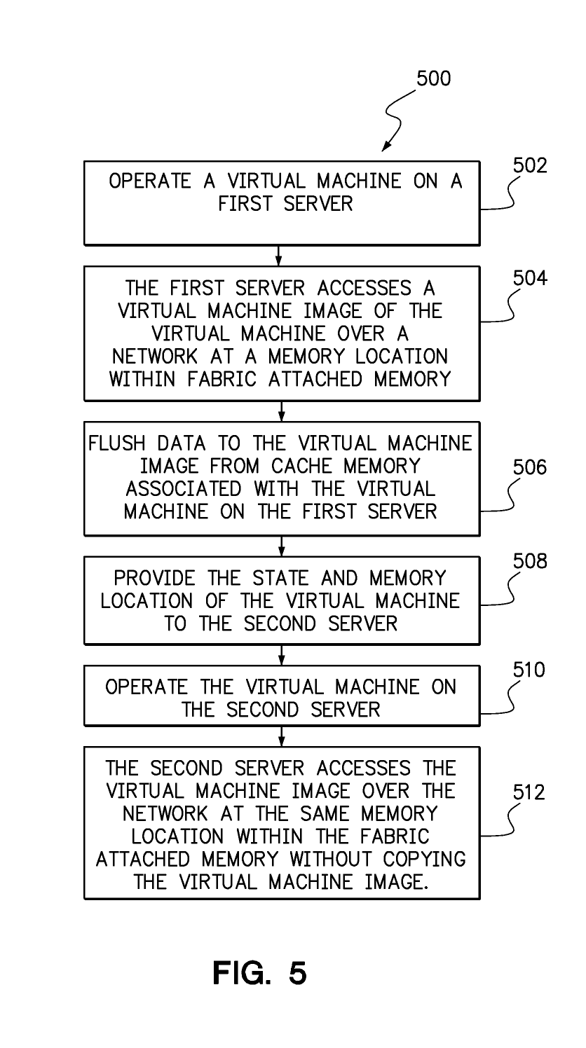

FIG. 5 is a flowchart of a computer implemented method 500. Step 502 includes operating a virtual machine on a first server. In step 504, the first server accesses a virtual machine image of the virtual machine over a network at a memory location within fabric attached memory. In order to migrate the virtual machine, data is flushed to the virtual machine image from cache memory associated with the virtual machine on the first server, in step 506, and the state and memory location of the virtual machine is provided to the second server, in step 508. The virtual machine operates on the second server in step 510, wherein the second server accesses the virtual machine image over the network at the same memory location within the fabric attached memory without copying the virtual machine image, as set out in step 512.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in one or more computer-readable storage medium having computer-usable program code stored thereon.

Any combination of one or more computer usable or computer readable storage medium(s) may be utilized. The computer-usable or computer-readable storage medium may be, for example but not limited to, an electronic, magnetic, electromagnetic, or semiconductor apparatus or device. More specific examples (a non-exhaustive list) of the computer-readable medium include: a portable computer diskette, a hard disk, random access memory (RAM), read-only memory (ROM), an erasable programmable read-only memory (EPROM or Flash memory), a portable compact disc read-only memory (CD-ROM), an optical storage device, or a magnetic storage device. The computer-usable or computer-readable storage medium could even be paper or another suitable medium upon which the program is printed, as the program can be electronically captured via, for instance, optical scanning of the paper or other medium, then compiled, interpreted, or otherwise processed in a suitable manner, if necessary, and then stored in a computer memory. In the context of this document, a computer-usable or computer-readable storage medium may be any storage medium that can contain or store the program for use by a computer. Computer usable program code contained on the computer-usable storage medium may be communicated by a propagated data signal, either in baseband or as part of a carrier wave. The computer usable program code may be transmitted from one storage medium to another storage medium using any appropriate transmission medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer implemented method, comprising:
operating a virtual machine on a first server, wherein the first server accesses the virtual machine image over a network at a memory location within fabric attached memory;
migrating the virtual machine from the first server to a second server by flushing data to the virtual machine image from cache memory associated with the virtual machine on the first server and providing the state and memory location of the virtual machine to the second server; and
operating the virtual machine on the second server, wherein the second server accesses the virtual machine image over the network at the same memory location within the fabric attached memory without copying the virtual machine image.

2. The computer implemented method of claim 1, wherein a first hypervisor on the first server provides the state and memory location of the virtual machine, and wherein a second hypervisor on the second server receives the state and memory location of the virtual machine.

3. The computer implemented method of claim 2, wherein the virtual machine migration from the first server to the second server is initiated by a provisioning manager.

4. The computer implemented method of claim 1, further comprising:
continuing to operate the virtual machine on the first server during migration.

5. The computer implemented method of claim 1, wherein the first and second servers are operably coupled within a multiserver chassis.

6. The computer implemented method of claim 1, further comprising:
a global provisioning manager communicating with provisioning managers of a plurality of multi-server chassis to coordinate inter-chassis migration of a virtual machine.

7. The computer implemented method of claim 1, further comprising:
allocating cache memory on the second server for use by the virtual machine after migration to the second server.

8. A computer program product including computer usable program code embodied on a computer usable storage medium, the computer program product comprising:
computer usable program code for operating a virtual machine on a first server, wherein the first server accesses the virtual machine image over a network at a memory location within fabric attached memory;
computer usable program code for migrating the virtual machine from the first server to a second server by flushing data to the virtual machine image from cache memory associated with the virtual machine on the first server and providing the state and memory location of the virtual machine to the second server; and
computer usable program code for operating the virtual machine on the second server, wherein the second server accesses the virtual machine image over the network at the same memory location within the fabric attached memory without copying the virtual machine image.

9. The computer program product of claim 8, wherein a first hypervisor on the first server provides the state and memory location of the virtual machine, and wherein a second hypervisor on the second server receives the state and memory location of the virtual machine.

10. The computer program product of claim 9, wherein the virtual machine migration from the first server to the second server is initiated by a provisioning manager.

11. The computer program product of claim 8, further comprising:
computer usable program code for continuing to operate the virtual machine on the first server during migration.

12. The computer program product of claim 8, wherein the first and second servers are operably coupled within a multiserver chassis.

13. The computer program product of claim 8, further comprising:
computer usable program code for a global provisioning manager communicating with provisioning managers of a plurality of multi-server chassis to coordinate inter-chassis migration of a virtual machine.

14. The computer program product of claim 8, further comprising:
computer usable program code for allocating cache memory on the second server for use by the virtual machine after migration to the second server.
